(19) United States
(12) Patent Application Publication
(10) Pub. No.: US 2014/0262018 A1
(43) Pub. Date: Sep. 18, 2014

(54) Hot Melt and Pressure Sensitive Adhesives that Include Highly-Plasticized Cellulose Esters and Methods and Articles Relating Thereto

(71) Applicant: CELANESE ACETATE LLC, Dallas, TX (US)

(72) Inventors: Michael Combs, Pembroke, VA (US); Wendy Bisset, Eggleston, VA (US); Lizbeth Milward, Blacksburg, VA (US)

(73) Assignee: Celanese Acetate LLC, Dallas, TX (US)

(21) Appl. No.: 13/796,234

(22) Filed: Mar. 12, 2013

(51) Int. Cl. C09J 101/12; C09J 5/00

(52) U.S. Cl. CPC C09J 101/12; C09J 5/00
USPC 156/328; 106/171.1; 106/15.05; 106/170.29; 106/170.16; 106/170.5

(57) ABSTRACT

Hot melt and pressure-sensitive adhesives may comprise highly-plasticized cellulose esters, e.g., a cellulose ester and a plasticizer, the plasticizer included in an amount of about 30% to about 60% by weight of the adhesive. A highly-plasticized cellulose ester adhesive may be utilized in a sheet form by disposing the adhesive sheet between a first surface and a second surface; and heating the adhesive sheet so as to adhere the first surface to the second surface.

### BACKGROUND

The present invention relates to hot melt and pressure-sensitive adhesives that comprise highly-plasticized cellulose esters, and methods and articles relating thereto.

As used herein, the term “hot melt adhesive” refers to an adhesive composition that is melted by heat, which at room temperature may be a solid, self-adhering solid, or a viscous liquid. Hot melt adhesives are useful in several applications from arts and crafts (e.g., hot glue sticks) to consumer products (e.g., cigarette seam line adhesives) to packaging (e.g., shipping box and cereal box adhesives). Some of the desired properties of hot melt adhesives include low-temperature flexibility, high adhesion strength, wettability, water-resistance, optical clarity, and the ability to accept a wide variety of modifications and additives. Further, the ability to tailor these and other properties of the hot melt adhesive would enhance the applicability of the hot melt adhesive across the plurality of applications thereof.

One of the most common hot melt adhesives is an ethylene vinyl acetate copolymer-based adhesive (“EVA-based adhesive”), which is often a mixture of an ethylene vinyl acetate copolymer (“EVA”), a wax, and optionally a tackifier. EVA-based adhesives provide many of the desirable properties described above, including tailorability based on the vinyl acetate content of the EVA. However, because the components of EVA-based adhesives are derived from petroleum precursors, a recent push has been made to develop environmentally-friendly hot melt adhesives derived from renewable resources.

### SUMMARY OF THE INVENTION

The present invention relates to hot melt and pressure-sensitive adhesives that comprise highly-plasticized cellulose esters, and methods and articles relating thereto.

Another embodiment of the present invention may be a method that includes disposing an adhesive sheet between a first surface and a second surface, the adhesive sheet comprising an adhesive that comprises a cellulose ester and a plasticizer, the plasticizer included in an amount of about 30% to about 60% by weight of the adhesive; and heating the adhesive sheet so as to adhere the first surface to the second surface.

Another embodiment of the present invention may be a method that includes compounding at least a cellulose ester and a plasticizer to yield an adhesive, the plasticizer included in an amount of about 30% to about 60% by weight of the adhesive; and forming the adhesive into an adhesive sheet.

Yet another embodiment of the present invention may be an adhesive sheet that includes a cellulose ester; and a plasticizer in an amount of about 30% to about 60% by weight of the adhesive.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A-E provide illustrations of nonlimiting examples of article configurations according to at least some embodiments of the present invention.

FIG. 2 provides the melt temperature as a function of intrinsic viscosity for highly-plasticized cellulose ester hot melt adhesives according to at least some embodiments of the present invention.

### DETAILED DESCRIPTION

The present invention relates to hot melt and pressure-sensitive adhesives that comprise highly-plasticized cellulose esters, and methods and articles relating thereto.

The present invention provides for, in some embodiments, highly-plasticized cellulose ester hot melt adhesives (“HPCE-adhesives”) that include plasticizers and cellulose esters, which can be derived from renewable sources like wood and grass. The discovery of HPCE-adhesives was quite surprising given the plurality of research conducted on plasticized cellulose ester compositions. Further, the adhesive strength of at least some embodiments of the HPCE-adhesives being comparable to that of EVA-based adhesives was unexpected.

The HPCE-adhesives described herein may, in some embodiments, have several advantageous properties like optical clarity, pressure-sensitive adhesive properties, high adhesion strength, and any combination thereof. Further, the HPCE-adhesives described herein may, in some embodiments, have a plurality of avenues through which these and other properties can be tailored, e.g., cellulose ester composition, cellulose ester molecular weight, plasticizer composition, plasticizer concentration, and the composition and concentrations of additives like tackifiers, antioxidants, and aromas.

In addition to being derived from renewable sources, the HPCE-adhesives described herein may be designed to be degradable over relatively short periods of time (e.g., weeks) to longer periods of time (e.g., months to years). This may advantageously enable articles and products that as a whole are more biodegradable than such articles and products utilizing other hot melt adhesives like EVA-based adhesives.

Further, the HPCE-adhesives described herein may be food-grade and utilize cellulose esters and plasticizers (e.g., cellulose diacetate and triacetin) that are approved for use in conjunction with food applications (e.g., food packaging) and other applications with an increased risk for oral ingestion by consumer (e.g., cigarette adhesives). As used herein, the term “food-grade” refers to a material that has been approved for contacting (directly or indirectly) food, which may be classified as based on the material's conformity to the requirements of the United States Pharmacopeia (“USP-grade”), the National Formulary (“NF-grade”), and/or the Food Chemicals Codex (“FCC-grade”).

It should be noted that when “about” is used in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

### I. HPCE-Adhesives and Methods Relating Thereto

In some embodiments, the HPCE-adhesives of the present invention may comprise cellulose esters and plasticizers, wherein the plasticizers are present in an amount of about 15% or greater by weight of the HPCE-adhesive. In some embodiments, the plasticizers may be present in HPCE-adhesives of the present invention in an amount ranging from a lower limit of about 15%, 30%, 40%, 50%, or 60% by weight of the HPCE-adhesive to an upper limit of about 80%, 70%, 60%, or 50% by weight of the HPCE-adhesive, wherein the amount may range from any lower limit to any upper limit and encompass any subset therebetween, e.g., about 20% to about 65%.

Cellulose esters suitable for use in conjunction with HPCE-adhesives of the present invention may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

Cellulose esters suitable for use in conjunction with HPCE-adhesives of the present invention may, in some embodiments, have a degree of substitution of the ester substituent ranging from a lower limit of about 0.5, 1.2, or 2 to an upper limit of less than about 3, about 2.9, 2.7, or 2.5, and wherein the degree of substitution may range from any lower limit to any upper limit and encompass any subset therebetween.

Cellulose esters suitable for use in conjunction with HPCE-adhesives of the present invention may, in some embodiments, have a molecular weight ranging from a lower limit of about 10,000, 15,000, 25,000, 50,000, or 85,000 to an upper limit of about 125,000, 100,000, or 85,000, and wherein the molecular weight may range from any lower limit to any upper limit and encompass any subset therebetween.

Cellulose esters suitable for use in conjunction with HPCE-adhesives of the present invention may be derived from any suitable cellulosic source. Suitable cellulosic sources may, in some embodiments, include, but are not limited to, softwoods, hardwoods, cotton linters, switchgrass, bamboo, bagasse, industrial hemp, willow, poplar, perennial grasses (e.g., grasses of the Miscanthus family), bacterial cellulose, seed hulls (e.g., soy beans), and the like, and any combination thereof. Further, it has been discovered that the clarity of HPCE-adhesives described herein may be minimally to not impacted by the cellulosic source from which the cellulose esters are derived, which is unexpected because some existing cellulose ester products that do not have adhesive properties require high quality, expensive cellulosic sources (e.g., hardwoods with low hemicellulose content) to achieve high clarity.

Plasticizers suitable for use in conjunction with the present invention may, in some embodiments, include, but are not limited to, triacetin, trimethyl phosphate, triethyl phosphate, tributyl phosphate, triphenyl phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methylpyrollidinone, propylene carbonate, C₁-C₂₀ diacid esters, dimethyl adipate (and other dialkyl esters), resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, aromas (including some described herein, e.g., eugenol, cinnamyl alcohol, camphor, methoxy hydroxy acetophenone (acetovanillone), vanillin, and ethylvanillin), and the like, any derivative thereof, and any combination thereof.

In some embodiments, plasticizers may be food-grade plasticizers. Examples of food-grade plasticizers may, in some embodiments, include, but are not limited to, triacetin, trimethyl citrate, triethyl citrate, tributyl citrate, eugenol, cinnamyl alcohol, methoxy hydroxy acetophenone (acetovanillone), vanillin, ethylvanillin, polyethylene glycols, and the like, and any combination thereof.

In some embodiments, the HPCE-adhesives of the present invention may further comprise additives. Additives suitable for use in conjunction with the HPCE-adhesives of the present invention may include, but are not limited to, tackifiers, crosslinkers, insolubilizers, starches, fillers, thickeners, rigid compounds, water-resistance additives, flame retardants, lubricants, softening agents, antibacterial agents, antifungal agents, pigments, dyes, antioxidants, UV-stabilizers, resins, rosins, waxes, flowing agents, viscosity modifiers, aromas, and the like, and any combination thereof.

In some embodiments, the additives may be present in HPCE-adhesives of the present invention in an amount ranging from a lower limit of about 0.1%, 1%, 5%, or 10% by weight of the HPCE-adhesive to an upper limit of about 25%, 20%, 15%, or 10% by weight of the HPCE-adhesive, wherein the amount may range from any lower limit to any upper limit and encompass any subset therebetween.

Tackifiers may, in some embodiments, increase the adhesive properties of the HPCE-adhesives described herein. Tackifiers suitable for use in conjunction with the HPCE-adhesives described herein may, in some embodiments, include, but are not limited to, methylcellulose, ethylcellulose, hydroxyethylcellulose, carboxy methylcellulose, carboxy ethylcellulose, amides, diamines, polyesters, polycarbonates, silyl-modified polyamide compounds, polycarbamates, urethanes, natural resins, natural rosins, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl(meth)acrylates, acrylamides, N-(dialkyl amino alkyl)acrylamide, methacrylamides, hydroxy alkyl(meth)acrylates, methacrylic acids, acrylic acids, hydroxyethyl acrylates, and the like, any derivative thereof, and any combination thereof.

In some embodiments, tackifiers suitable for use in conjunction with the HPCE-adhesives described herein may be food-grade tackifiers. Examples of food-grade tackifiers may, in some embodiments, include, but are not limited to, methylcellulose, ethylcellulose, hydroxyethylcellulose, carboxy methylcellulose, carboxy ethylcellulose, natural resins, natural rosins, and the like, and any combination thereof.

Crosslinkers may, in some embodiments, increase the adhesive properties and/or increase water-resistance of the HPCE-adhesives described herein. Crosslinkers suitable for use in conjunction with the HPCE-adhesives described herein may, in some embodiments, include, but are not limited to, zirconium salts, boric acid, borate salts, ammonium zirconium carbonate, potassium zirconium carbonate, metal chelates (e.g., zirconium chelates, titanium chelates, or aluminum chelates), formaldehyde crosslinkers, polyamide epichlorohydrin resin, crosslinkers containing N-methylol groups and/or etherified N-methylol groups (e.g., ARKOFIX® (an ultra-low formaldehyde crosslinking agent, available from Clariant)), glyoxal, urea glyoxal adduct crosslinkers, urea formaldehyde adduct crosslinkers, melamine formaldehyde, 4,5-dihydroxy-N,N′-dimethylolethyleneurea, hydroxymethylated cyclic ethyleneureas, hydroxymethylated cyclic propyleneureas, hydroxymethylated bicyclic glyoxal diurea, hydroxymethylated bicyclic malonaldehyde diureas, dialdehydes, protected dialdehydes, bisulfite protected aldehydes, isocyanates, blocked isocyanates, dimethyoxytetrahydrafuran, dicarboxylic acids, epoxides, diglycidyl ether, hydroxymethyl-substituted imidazolidinone, 1,3-dimethylol-4,5-dihydroxyimidazolidinone, hydroxymethyl-substituted pyrimidinones, hydroxymethyl-substituted triazinones, oxidized starch, oxidized polysaccharides, oxidized hemicellulose, and the like, any derivative thereof, and any combination thereof. One skilled in the art with the benefit of this disclosure should understand that formaldehyde crosslinkers should be excluded from use in conjunction with formaldehyde-free HPCE-adhesives, and limited in substantially formaldehyde-free HPCE-adhesives (i.e., the adhesive comprising less than 0.01% formaldehyde by weight of the adhesive).

In some embodiments, crosslinkers suitable for use in conjunction with the HPCE-adhesives described herein may be food-grade tackifiers. Examples of food-grade crosslinkers may, in some embodiments, include, but are not limited to, epoxidized soy oil, epoxidized linseed oil, and the like, and any combination thereof.

Water-resistance additives may, in some embodiments, increase the water-resistance properties of the HPCE-adhesives described herein, which may consequently yield articles capable of maintaining their mechanical properties in environments with higher water concentrations, e.g., humid environments. Water-resistance additives suitable for use in conjunction with the HPCE-adhesives described herein may, in some embodiments, include, but are not limited to, waxes, polyolefins, insolublizers, octenyl succinyls, and the like, and any combination thereof.

In some embodiments, crosslinkers suitable for use in conjunction with the HPCE-adhesives described herein may be food-grade tackifiers. Examples of food-grade crosslinkers may, in some embodiments, include, but are not limited to, waxes, polyolefins, and the like, and any combination thereof.

Fillers may, in some embodiments, increase the rigidity of the HPCE-adhesives described herein, which may consequently increase the mechanical rigidity of a article produced therewith. Fillers suitable for use in conjunction with the HPCE-adhesives described herein may, in some embodiments, include, but are not limited to, coconut shell flour, walnut shell flour, wood flour, wheat flour, soybean flour, gums, starches, protein materials, calcium carbonate, talc, zeolite, clay, rigid compounds (e.g. lignin), thickeners, and the like, and any combination thereof.

In some embodiments, fillers suitable for use in conjunction with the HPCE-adhesives described herein may be food-grade tackifiers. Examples of food-grade fillers may, in some embodiments, include, but are not limited to, coconut shell flour, walnut shell flour, wood flour, wheat flour, soybean flour, gums, starches, protein materials, calcium carbonate, and the like, and any combination thereof.

Flame retardants suitable for use in conjunction with the HPCE-adhesives described herein may, in some embodiments, include, but are not limited to, silica, phosphates, catechol phosphates, resorcinol phosphates, aromatic polyhalides, and the like, and any combination thereof.

Antifungal agents suitable for use in conjunction with the HPCE-adhesives described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, and any combination thereof.

Pigments and dyes suitable for use in conjunction with the HPCE-adhesives described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with the HPCE-adhesives described herein may be food-grade tackifiers. Examples of food-grade pigments and dyes may, in some embodiments, include, but are not limited to, plant dyes, vegetable dyes, and the like, and any combination thereof.

Antioxidants may, in some embodiments, mitigate oxidation and/or chemical degradation of the HPCE-adhesives described herein during storage, transportation, and/or implementation. Antioxidants suitable for use in conjunction with the HPCE-adhesives described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, ubiquinol, gallic acids, melatonin, secondary aromatic amines, benzofuranones, hindered phenols, polyphenols, hindered amines, organophosphorus compounds, thioesters, benzoates, lactones, hydroxylamines, and the like, and any combination thereof.

In some embodiments, antioxidants suitable for use in conjunction with the HPCE-adhesives described herein may be food-grade tackifiers. Examples of food-grade antioxidants may, in some embodiments, include, but are not limited to, ascorbic acid, vitamin A, tocopherols, and the like, and any combination thereof.

Viscosity modifiers may, in some embodiments, be advantageous in modifying the melt flow index of the HPCE-adhesives described herein and/or modify the viscosity of HPCE-adhesives described herein that are in a paste or putty form. Viscosity modifiers suitable for use in conjunction with the HPCE-adhesives described herein may, in some embodiments, include, but are not limited to, polyethylene glycols, and the like, and any combination thereof, which, in some embodiments, may be a food-grade viscosity modifier.

Aromas suitable for use in conjunction with the HPCE-adhesives described herein may, in some embodiments, include, but are not limited to, spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vannillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, bergamot, strawberry, carnation, oregano, honey, civet, heliotrope, caramel, coumarin, patchouli, dewberry, helonial, bergamot, hyacinth, coriander, pimento berry, labdanum, cassie, bergamot, aldehydes, orchid, amber, benzoin, orris, tuberose, palmarosa, cinnamon, nutmeg, moss, styrax, pineapple, bergamot, foxglove, tulip, wisteria, clematis, ambergris, gums, resins, civet, peach, plum, castoreum, civet, myrrh, geranium, rose violet, jonquil, spicy carnation, galbanum, hyacinth, petitgrain, iris, hyacinth, honeysuckle, pepper, raspberry, benzoin, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, sering a, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, That benzoin, Tunisian orange blossom, Yugoslavian oakmoss, Virginian cedarwood, Utah yarrow, West Indian rosewood, and the like, and any combination thereof.

In some embodiments, HPCE-adhesives of the present invention may be food-grade HPCE-adhesives that comprise food-grade cellulose esters and food-grade plasticizers and optionally further comprise food-grade additives.

In some embodiments, the HPCE-adhesives of the present invention may comprise cellulose esters (e.g., having an ester substituent described herein, a degree of substitution described herein, a molecular weight described herein, from a cellulosic source described herein, and a combination thereof), plasticizers (e.g., one or more specific plasticizers describe herein, food-grade plasticizers described herein, aroma plasticizers described herein, and a combination thereof), and optionally additive described herein (e.g., one or more specific additives describe herein, at amounts described herein, and a combination thereof), wherein the plasticizers are present in an amount of about 15% or greater by weight of the HPCE-adhesive (including specific ranges described herein or subsets thereof).

The physical and chemical properties of cellulose esters and plasticizers described herein may be tailored to achieve the desired characteristics of the HPCE-adhesives. Examples of such properties may include, but are not limited to, the composition of the ester substituents of the cellulose esters, the degree of substitution of the ester substituent of the cellulose esters, the molecular weight of the cellulose esters, the composition of the plasticizers, and the like, and any combination thereof. Further, the amount of plasticizer in the HPCE-adhesives described herein may be tailored to achieve the desired characteristics of the HPCE-adhesives.

The characteristics of the HPCE-adhesives described herein that can be tailored may include, but are not limited to, flow onset point, glass transition temperature, melt flow index, adhesive strength, degradability, clarity, and the like, and any combination thereof.

Tailoring the flow onset of the HPCE-adhesives described herein may enable use of the HPCE-adhesives over a wide variety of applications. For example, a lower flow onset points may be useful in pressure-sensitive HPCE-adhesives, while higher flow onset points may be useful in thermal laminating sheets, each application of which are discussed in more detail herein. In some embodiments, tailoring the flow onset point of the HPCE-adhesives described herein may be achieved by, inter alia, changing the plasticizer concentration (e.g., decreasing the concentration to increase the flow onset point), changing plasticizer composition, changing the degree of substitution or composition of the cellulose ester, and changing the molecular weight of the cellulose ester (e.g., decreasing molecular weight to decrease the flow onset point).

In some embodiments, the HPCE-adhesives described herein may have a flow onset point of about 220° C. or less. In some embodiments, the HPCE-adhesives described herein may have a flow onset point ranging from a lower limit of about 70° C., 80° C., 100° C., 110° C., 130° C., or 150° C. to an upper limit of about 220° C., 200° C., 170° C., 150° C., 130° C., or 110° C., and wherein the flow onset point may range from any lower limit to any upper limit and encompass any subset therebetween. In some embodiments, the HPCE-adhesives described herein may have no flow onset point.

In some embodiments, the HPCE-adhesives described herein may exhibit visual flow under a gravitation load (i.e., no additional load) at a temperature ranging from a lower limit of about 75° C., 100° C., 125° C., or 150° C. to an upper limit of about 220° C., 200° C., 175° C., or 150° C., and wherein the flow onset point may range from any lower limit to any upper limit and encompass any subset therebetween.

Tailoring the glass transition temperature of the HPCE-adhesives described herein may alter the physical characteristics of the HPCE-adhesive at ambient conditions, e.g., stiff or flexible, brittle or pliable, smooth or tacky, and the like, and any combination thereof. As used herein, the term “tacky” refers to a composition that is at least sticky to the touch at room temperature. For example, HPCE-adhesives having no detectable glass transition temperature may be more tacky and flexible than those having a glass transition temperature. As used herein, the term “no detectable glass transition temperature” and derivatives thereof refers to material having no detectible heat flow event (as measured by DSC), which may be caused by the plasticized material having no glass transition temperature or the heat flow broadening to an extent that the glass transition temperature is not detectable.

In another example, HPCE-adhesives having higher glass transition temperatures may be more stiff and brittle than those having moderate to low glass transition temperatures. In some embodiments, tailoring the glass transition temperature of the HPCE-adhesives described herein may be achieved by, inter alia, changing the plasticizer concentration (e.g., increasing the concentration to decrease the glass transition temperature), changing the composition of the plasticizer, changing the molecular weight, and changing the degree of substitution of the cellulose ester (e.g., in some instances, increasing the degree of substitution to decrease the glass transition temperature).

In some embodiments, the HPCE-adhesives described herein may have a glass transition temperature of about 190° C. or less. In some embodiments, the HPCE-adhesives described herein may have a glass transition temperature ranging from a lower limit of not measurable, about −55° C., 10° C., 75° C., 120° C., 130° C., or 150° C. to an upper limit of about 190° C., 175° C., or 150° C., and wherein the glass transition temperature may range from any lower limit to any upper limit and encompass any subset therebetween. The glass transition temperature of an HPCE-adhesive can be measured by either differential scanning calorimetry or rheology.

Tailoring the melt flow index of HPCE-adhesives described herein may enable the use of the HPCE-adhesives over a wide variety of applications. For example, lower melt flow index HPCE-adhesives may be useful in applications where shape is retained until heating (e.g., window films, glue sticks, and pelletized HPCE-adhesives), while higher melt flow index HPCE-adhesives may be useful in applications where a pliable or even spreadable HPCE-adhesives are desired (e.g., for creating thin films for self-adhesive stamps and envelopes). In some embodiments, tailoring the melt flow index of the HPCE-adhesives described herein may be achieved by, inter alia, changing the plasticizer composition, changing the plasticizer concentration (e.g., increasing the concentration to decrease the melt flow index), changing the molecular weight of the cellulose ester (e.g., decreasing molecular weight to decrease the melt flow index), and changing the composition and/or concentration of additives (e.g., increasing crosslinker concentration to increase the melt flow index).

In some embodiments, the HPCE-adhesives described herein may have a melt flow index ranging from a lower limit of about 25 g/10 min, 29 g/10 min, 35 g/10 min, or 40 g/10 min (at 130° C./2.16 kg) to an upper limit of about 86 g/10 min, 80 g/10 min, 70 g/10 min, 60 g/10 min, 50 g/10 min, or 40 g/10 min (at 125° C./500 g), and wherein the melt flow index may range from any lower limit to any upper limit and encompass any subset therebetween. It should be noted that the melt flow index of the HPCE-adhesives described herein may fall outside the ranges described herein depending on, inter alia, the additive (e.g., fillers, tackifiers, and the like), included in the adhesive. In some embodiments, the HPCE-adhesives described herein may have a melt flow index that is higher than can be measured at 125° C./500 g, e.g., greater than about 86 g/10 min at 125° C./500 g kg.

Tailoring the adhesive strength of HPCE-adhesives described herein may enable the use of the HPCE-adhesives over a wide variety of applications. For example, a lower adhesive strength may be useful in semi-permanent adhesive applications between substrates with lower mechanical properties (e.g., sticky-notes), while higher adhesive strength may be useful in permanent to semi-permanent applications between substrates with higher mechanical properties (e.g., adhering the cardboard packaging of mailing boxes or laminating applications). In some embodiments, tailoring the adhesive strength of the HPCE-adhesives described herein may be achieved by, inter alia, changing the plasticizer composition, changing the plasticizer concentration (e.g., increasing the concentration to decrease the adhesive strength), changing the molecular weight of the cellulose ester (e.g., decreasing molecular weight to decrease the adhesive strength), and changing the composition and/or concentration of additives (e.g., increasing crosslinker and/or tackifier concentration to increase the adhesive strength).

In some embodiments, the HPCE-adhesives described herein may have an adhesive shear strength ranging from a lower limit of about 0.2 kgf, 0.5 kgf, 1 kgf, 2 kgf, or 4 kgf to an upper value limited by the force required to tear the substrate, and wherein the adhesive shear strength may range from any lower limit to any upper limit and encompass any subset therebetween. In some embodiments, the HPCE-adhesives described herein may have an adhesive shear strength ranging from a lower limit of about 0.2 kgf, 0.5 kgf, 1 kgf, 2 kgf, or 4 kgf to an upper limit of about 10 kgf, 8 kgf, 8 kgf, 6 kgf, or 4 kgf, and wherein the adhesive shear strength may range from any lower limit to any upper limit and encompass any subset therebetween. The adhesive shear strength of an HPCE-adhesive can be measured by testing lap shears by tension loading with a 1 kN load cell by a method that includes placing a specimen in the grips of the testing machine so that each end is in contact with the grip assemble, applying the loading immediately to the specimen at the rate of 800 lb force of shear per min, and continuing the load to failure. Substrate failure was observed up to the strength of 8 kgf.

Tailoring the degradability of HPCE-adhesives described herein may contribute to the overall degradability of products and articles comprising the HPCE-adhesives. In some embodiments, tailoring the degradability of the HPCE-adhesives described herein may be achieved by, inter alia, changing the plasticizer composition (e.g., utilizing a plasticizer that leaches from the HPCE-adhesive at a higher rate to increase the degradability), changing the plasticizer concentration (e.g., increasing the concentration to increase the degradability), changing the degree of substitution of the cellulose ester (e.g., decreasing the degree of substitution to increase the degradability), and changing the composition and/or concentration of additives (e.g., increasing antioxidant and/or stabilizer concentration to decrease the degradability).

In some embodiments, the HPCE-adhesives described herein may degrade to a greater extent than a cellulose diacetate material plasticized with 40% triacetin. In some embodiments, the HPCE-adhesives may degrade by about 5% or greater by weight than a cellulose diacetate material plasticized with 40% triacetin in a procedure performed according to EN13432 “Requirements for Packaging Recoverable through Composting and Biodegradation—Test Scheme and Evaluation Criteria for the Final Acceptance of Packaging.” In some embodiments, the HPCE-adhesives may degrade by an amount ranging from a lower limit of about 5%, 10%, or 15% to an upper limit of about 50%, 40%, or 30% by weight than a cellulose diacetate material plasticized with 40% triacetin in a procedure performed according to EN13432 “Requirements for Packaging Recoverable through Composting and Biodegradation—Test Scheme and Evaluation Criteria for the Final Acceptance of Packaging,” and wherein the degradation may range from any lower limit to any upper limit and encompass any subset therebetween.

The clarity of the HPCE-adhesives described herein may be important in some applications, e.g., high clarity (or low haze) may be necessary when the HPCE-adhesives are used in conjunction with high clarity (or low haze) films (e.g., window tints or CLARIFOIL® packaging). In some embodiments, tailoring the clarity of the HPCE-adhesives described herein may be achieved by, inter alia, changing the plasticizer concentration (e.g., increasing the concentration to decrease the clarity/increasing the haze) and changing the composition and/or concentration of additives (e.g., increasing the filler concentration to decrease the clarity/increase the haze).

In some embodiments, the HPCE-adhesives described herein may have a haze ranging from a lower limit of about 7, 10, 15, 20, or 25 to an upper limit of about 45, 40, 35, 30, or 25, and wherein the haze may range from any lower limit to any upper limit and encompass any subset therebetween. The haze of an HPCE-adhesive can be measured with properly sized specimens substantially plane-parallel surfaces (e.g., flat without wrinkling) free of dust, scratches, and particles of about 0.85 mm in thickness using an UtraScan Pro from Hunter Lab with haze setting of D65/10.

Some embodiments of the present invention may involve producing HPCE-adhesives described herein, which may involve compounding cellulose esters described herein and plasticizers described herein at a suitable concentration. Some embodiments may involve using the HPCE-adhesives immediately for an application, while other embodiments may involve forming the HPCE-adhesives into a desired form. Depending on their characteristics, the HPCE-adhesives described herein may be in a desired form, e.g., a paste, a putty, pellets, or a molded shape (e.g., a glue stick or an adhesive sheet). It should be noted that the term “sheet” should not be interpreted to be limited in thickness and encompasses films, layers, and the like.

In some embodiments, HPCE-adhesives in sheet form may comprise plasticizers in an amount ranging from a lower limit of about 30%, 35%, or 40% to an upper limit of about 50%, 45%, or 40% by weight of the HPCE-adhesive, and wherein the amount may range from any lower limit to any upper limit and encompasses any subset therebetween. In some embodiments, the HPCE-adhesives in sheet form may be smooth and substantially non-tacky at room temperature. In some embodiments, the HPCE-adhesives in sheet form may be heated to initiate adhesion to a surface.

In some embodiments, HPCE-adhesives in pellet form or molded shapes may comprise plasticizers in an amount ranging from a lower limit of about 30%, 35%, or 40% to an upper limit of about 65%, 55%, or 45% by weight of the HPCE-adhesive, and wherein the amount may range from any lower limit to any upper limit and encompasses any subset therebetween. In some embodiments, HPCE-adhesives in pellet form or molded shapes may be tacky. In some embodiments, the HPCE-adhesives in pellet form or molded shapes may be smooth and substantially non-tacky at room temperature. The suitable amount of plasticizer in the HPCE-adhesives to achieve pellet form or molded shapes may depend on, inter alia, the degree of substitution of the cellulose esters, the composition of the cellulose esters, the molecular weight of the cellulose esters, and the composition of the plasticizers.

In some embodiments, HPCE-adhesives in a paste or putty form may comprise plasticizers in an amount of about 40% or greater by weight of the HPCE-adhesive. In some embodiments, HPCE-adhesives in a paste or putty form may comprise plasticizers in an amount of about 40%, 45%, 50%, or 60% to an upper limit of about 80%, 75%, 70%, 65%, or 60% by weight of the HPCE-adhesive, and wherein the amount may range from any lower limit to any upper limit and encompasses any subset therebetween. In some embodiments, HPCE-adhesives in a paste or putty form may be tacky. In some embodiments, HPCE-adhesives in a paste or putty form may be smooth and substantially non-tacky. The suitable amount of plasticizer in the HPCE-adhesives to achieve a paste or putty form may depend on, inter alia, the degree of substitution of the cellulose esters, the composition of the cellulose esters, the molecular weight of the cellulose esters, and the composition of the plasticizers.

Forming the HPCE-adhesives into a desired form may, in some embodiments, be a consequence of compounding, e.g., a paste or a putty. Forming the HPCE-adhesives into a desired form may, in some embodiments, involve methods like extruding, injection molding, blow molding, over molding, compression molding, casting, calendaring, near net shape molding, and the like, any hybrid thereof, and any combination thereof.

In some embodiments, additives may be incorporated into HPCE-adhesives by inclusion in the compounding step. In some embodiments, additives may be incorporated into HPCE-adhesives after the compounding step by, for example, absorption. Absorption may, in some embodiments, be advantageous for the incorporation volatile additives and/or small molecule additives, e.g., some fragrances, aromas, dyes, and pigments.

### II. Articles Comprising HPCE-Adhesives and Methods Relating Thereto

In some embodiments, an article of the present invention may comprise a first surface having an HPCE-adhesive described herein disposed thereon such that the HPCE-adhesive is exposed to the local environment, e.g., a window tint, window film, light films, and light filters.

In some embodiments, an article of the present invention may comprise a first surface adhered to a second surface within HPCE-adhesive described herein. In some embodiments, at least one of the surfaces may be chosen so as to be releasable (e.g., a peelable layer) from the HPCE-adhesive, e.g., an envelope with an adhesive between the paper and a release strip. In some embodiments, the first surface and the second surface may correspond to a first substrate and a second substrate, respectively. In some embodiments, the first surface and the second surface may correspond to a single substrate, e.g., a single piece of paper rolled into a cylinder and adhered to itself. In some embodiments, articles of the present invention may be extended to three or more surfaces, including hundreds or thousands of surfaces (e.g., adhesive book bindings), without departing from the present invention.

In some embodiments, the articles of the present invention may be designed with the first surface and the second surface adhered in any suitable configuration. Examples of suitable configurations may, in some embodiments, include, but are not limited to, those illustrated in FIG. 1. FIG. 1A illustrates a first substrate 101 and a second substrate 102 adhered together with an HPCE-adhesive 100a in a stacked configuration. FIG. 1B illustrates a first substrate 103 and a second substrate 104 adhered together with an HPCE-adhesive 100b in a side-by-side configuration. FIG. 1C illustrates a first substrate 105, a second substrate 106, and a third substrate 107 adhered together with an HPCE-adhesive 100c,100d in a stacked configuration where each substrate 105,106,107 has different sizes. FIG. 1D illustrates a plurality of substrates in a hybrid configuration, wherein substrates 109,110,111 are each embedded at one end in an HPCE-adhesive 100e which further adheres substrates 109,110,111 to substrate 108. FIG. 1E illustrates a substrate 112 rolled and adhered to itself at a seam with an HPCE-adhesive 100f. One skilled in the art with the benefit of this disclosure should recognize that FIGS. 1A-1E are merely examples of possible configurations of articles described herein and that a multitude of other configurations are possible and within the bounds of this disclosure.

Exemplary examples of articles of the present invention comprising HPCE-adhesives and at least one fibrous substrate (or surface) as described herein may, in some embodiments, include, but are not limited to, smoking articles (e.g., cigarettes), envelopes, tape, cardboard packaging (e.g., mailing packages and food containers like cereal boxes and frozen dinner containers), books, notebooks, magazines, sticky-notes, corrugated boxes, decorative boxes, paper bags, grocery bags, wrapping paper, wallpaper, paper honeycomb, emery boards, electric insulation paper, air filters, papier-mâché articles, carpets, dartboards, furniture or components thereof (e.g., carpet and/or fabric coated headboards, chairs, and stools), picture frames, medical garments (e.g., disposable gowns and surgical masks), self-adhesive labels, self-adhesive stamps, self-adhesive window coverings (e.g., decorative window stickers, window films, and window tinting), light films, light filters, and the like.

Substrates or surfaces suitable for use in conjunction with articles described herein may, in some embodiments, include, but are not limited to, fibers, woven fiber substrates, nonwoven fiber substrates, foamed substrates, solid substrates, and the like, any hybrid thereof, and any combination thereof.

Substrates or surfaces suitable for use in conjunction with articles described herein may, in some embodiments, comprise materials that include, but are not limited to, ceramics, natural polymers, synthetic polymers, metals, natural materials, carbons, and the like, and any combination thereof. Examples of ceramics may, in some embodiments, include, but are not limited to, glass, quartz, silica, alumina, zirconia, carbide ceramics, boride ceramics, nitride ceramics, and the like, and any combination thereof. Examples of natural polymers may, in some embodiments, include, but are not limited to, cellulose, and the like, any derivative thereof, and any combination thereof. Examples of synthetic polymers may, in some embodiments, include, but are not limited to, cellulose diacetate, cellulose triacetate, synthetic bamboo, rayon, acrylic, aramid, nylon, polyolefins, polyethylene, polypropylene, polyesters, polyamides, zylon, and the like, any derivative thereof, and any combination thereof. Examples of metals may, in some embodiments, include, but are not limited to, steel, stainless steel, aluminum, copper, and the like, any alloy thereof, and any combination thereof. Examples of natural materials may, in some embodiments, include, but are not limited to, wood, grass, animal hide, and the like, and any combination thereof. Examples of carbons may, in some embodiments, include, but are not limited to, carbon fibers, and the like, any derivative thereof, and any combination thereof.

Exemplary examples of substrates suitable for use in conjunction with the articles described herein may, in some embodiments, include, but are not limited to, paper, cardboard, card stock, sand paper, bond paper, wallpaper, wrapping paper, cotton paper, tipping paper, bleached paper, colored paper, construction paper, sisal paper, coated paper, wax paper, CLARIFOIL® (cellulose diacetate, available from Celanese Corporation), woven fabrics, continuous filament nonwoven fabrics, carded nonwoven fabrics, tow, fiber bundles, twill, twine, rope, carpet, carpet backing, leather, animal hide, insulation, wood and/or grass derived substrates (e.g., wood veneers, particle board, fiberboard, medium-density fiberboard, high-density fiberboard, oriented strand board, cork, hardwoods (e.g., balsa wood, beech, ash, birch, Brazil wood, cherry, chestnut, elm, hickory, mahogany, maple, oak, rosewood, teak, walnut, locust, mango, alder, and the like), softwoods (e.g., pine, fir, spruce, cedar, hemlock, and the like), rough lumber, finished lumber, natural fibrous material, and bamboo), foam substrates (e.g., memory foams, polymer foams, polystyrene foam, polyurethane foam, frothed polyurethane, and soy-based foams), and the like, and any combination thereof.

By way of nonlimiting example, an article (e.g., a cigarette paper or a paper towel roll) may comprise two surfaces of a single substrate (e.g., a tipping paper or a cardboard) adhered together (e.g., at a seam line) with HPCE-adhesives described herein.

By way of another nonlimiting example, an article (e.g., a cardboard container for shipping or containing food) may comprise two surfaces adhered together with HPCE-adhesives described herein.

By way of yet another nonlimiting example, an article (e.g., a food container) may comprise two surfaces (e.g., a cardboard container and a cellulose diacetate film (like CLARIFOIL®)) adhered together with HPCE-adhesives described herein.

By way of another nonlimiting example, an article (e.g., window tints or window coverings) may comprise a first surface (e.g., a polyester film) with HPCE-adhesives described herein disposed thereon so as to allow for adherence to a second surface (e.g., a glass surface or other similar transparent surface). In some embodiments, the article may comprise, in order, the first surface, the HPCE-adhesives, and a peelable layer that can be removed before adherence to the second surface. In some embodiments, the article may comprise HPCE-adhesives that are smooth and substantially non-tacky at room temperature such that a peelable layer is not required and the HPCE-adhesives may be exposed to air. In such embodiments, heat may be utilized in adhering the first surface to the second surface.

Some embodiments of the present invention may involve adhering two or more surfaces together using HPCE-adhesives described herein. In some embodiments, adhering may involve heating the HPCE-adhesives and/or applying pressure to the HPCE-adhesives.

In some embodiments, adhering surfaces together may involve heating an HPCE-adhesive described herein to yield an adhesive melt; applying the adhesive melt to a first surface; and adhering a second surface to the first surface with the adhesive. While any of the HPCE-adhesives described herein may be suitable for producing adhesive melts, in some preferred embodiments, HPCE-adhesives used for producing adhesive melts may comprise plasticizers in an amount of about 15% to about 70% by weight of the adhesive composition.

In some embodiments wherein an HPCE-adhesive described herein is tacky, adhering surfaces together may involve applying the HPCE-adhesive to a first surface; and adhering a second surface to the first surface with the HPCE-adhesive.

In some embodiments, adhering surfaces together may involve disposing an adhesive sheet between a first surface and a second surface; and heating the adhesive sheet so as to adhere the first surface and the second surface together.

Embodiments Disclosed Herein Include:

A. a method that includes disposing an adhesive sheet between a first surface and a second surface, the adhesive sheet comprising an adhesive that comprises a cellulose ester and a plasticizer, the plasticizer included in an amount of about 30% to about 60% by weight of the adhesive; and heating the adhesive sheet so as to adhere the first surface to the second surface;

B. a method that includes compounding at least a cellulose ester and a plasticizer to yield an adhesive, the plasticizer included in an amount of about 30% to about 60% by weight of the adhesive; and forming the adhesive into an adhesive sheet; and

C. an adhesive sheet that includes a cellulose ester; and a plasticizer in an amount of about 30% to about 60% by weight of the adhesive.

Each of embodiments A, B, and C may have one or more of the following additional elements in any combination: Element 1: the adhesive having a flow onset point between about 75° C. and about 180° C.; Element 2: the adhesive having a glass transition temperature between about 10° C. and about 190° C. or the adhesive having the adhesive having no detectable glass transition temperature; Element 3: the cellulose ester having a degree of substitution between about 1.5 and about 2.7; Element 4: the cellulose ester comprising at least one organic ester substituent selected from the group consisting of a C₁-C₂₀ aliphatic ester, a functional C₁-C₂₀ aliphatic ester, acetate, propionate, butyrate, succinate, glutarate, maleate, an aromatic ester, a substituted aromatic ester, any derivative thereof, and any combination thereof; Element 5: the cellulose ester having a molecular weight between about 10,000 and about 125,000; Element 6: the plasticizer being a food-grade plasticizer; and Element 7: the plasticizer comprising at least one selected from the group consisting of triacetin, trimethyl phosphate, triethyl phosphate, tributyl phosphate, triphenyl phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate, an di-octyl phthalate isomer, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methylpyrollidinone, propylene carbonate, C₁-C₂₀ diacid esters, dimethyl adipate, a dialkyl ester, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, an aroma, eugenol, cinnamyl alcohol, camphor, methoxy hydroxy acetophenone, vanillin, ethylvanillin, any derivative thereof, and any combination thereof.

Each of embodiments A and B may have one or more of the following additional elements in any combination: Element 8: the first surface and/or the second surface comprising at least one selected from the group consisting of a ceramic, a natural polymer, a synthetic polymer, a metal, a natural material, carbon, and any combination thereof; Element 9: producing an article selected from the group consisting of an envelope, tape, cardboard packaging, a mailing package, a food container, a cereal box, a frozen dinner container, a book, a notebook, a magazine, a corrugated box, a decorative box, a paper bag, a grocery bag, electric insulation paper, an air filter, furniture or a component thereof, carpet or fabric coated headboard, a chair, a stool, and a picture frame; and Element 10: absorbing an additive into the adhesive sheet, wherein the additive comprises at least one selected from the group consisting of a crosslinker, a lubricant, a softening agent, an antibacterial agent, an antifungal agent, a pigment, a dye, a flavorant, an aroma, and any combination thereof.

By way of non-limiting examples, exemplary combinations applicable to A, B, C include: Elements 1 and 2 in combination; Elements 2 and 3 in combination; Elements 1 and 3 in combination; Elements 1, 2, and 3 in combination; Element 6 in combination with any one or more of Elements 1-5 and 7; and so on. By way of additional non-limiting examples, exemplary combinations applicable to A and B include: Elements 1 and 2 in combination; Elements 2 and 3 in combination; Elements 1 and 3 in combination; Elements 1, 2, and 3 in combination; Element 6 in combination with any one or more of Elements 1-5 and 7; any of the foregoing in combination with Element 8; any of the foregoing in combination with Element 9; and so on.

To facilitate a better understanding of the present invention, the following examples of preferred or representative embodiments are given. In no way should the following examples be read to limit, or to define, the scope of the invention.

### EXAMPLES

### Example 1

A plurality of HPCE-adhesive samples were prepared by compounding cellulose acetate and a plasticizer in the amounts and compositions detailed in Table 1. The cellulose acetates tested were CA-1 having a degree of substitution of about 2.5 and a molecular weight (Mₙ) of about 78,000, CA-2 having a degree of substitution of about 2.4 and a Mₙ of about 44,000, and CA-3 having a degree of substitution of about 2.4 and a Mₙ of about 62,000. The characteristics of the HPCE-adhesive samples and control cellulose acetate samples without plasticizer were measured and are reported in Table 2.

TABLE 1

| | Cellulose | | |
|---|---|---|---|
| | Acetate | Plasticizer | |
| Sample | Composition | Composition | Wt % Plasticizer |
| CA-1 | CA-1 | | 0 |
| HPCE-1 | CA-1 | triacetin | 20 |
| HPCE-2 | CA-1 | triacetin | 40 |
| HPCE-3 | CA-1 | triacetin | 60 |
| HPCE-4 | CA-1 | tributyl phosphate | 20 |
| HPCE-5 | CA-1 | tributyl phosphate | 40 |
| HPCE-6 | CA-1 | tributyl phosphate | 60 |
| CA-2 | CA-2 | | 0 |
| HPCE-7 | CA-2 | triacetin | 60 |
| HPCE-8 | CA-2 | triacetin | 70 |
| HPCE-9 | CA-2 | tributyl phosphate | 60 |
| CA-3 | CA-3 | | 0 |
| HPCE-10 | CA-3 | triacetin | 60 |
| HPCE-11 | CA-2 | eugenol | 50 |
| HPCE-12 | CA-2 | ethylvanillin | 50 |
| HPCE-13 | CA-2 | triacetin and | 62 (92:8 triacetin: |
| | | ethylvanillin | ethylvanillin) |
| HPCE-14 | CA-2 | triacetin and | 64 (84:16) |
| | | ethylvanillin | |
| HPCE-15 | CA-2 | acetovanillone | 50 |
| HPCE-16 | CA-2 | triacetin and | 62 (92:8) |
| | | acetovanillone | |

TABLE 2

| | | | | Complex |
|---|---|---|---|---|
| | | | | Viscosity³ |
| Sample | Description | MP¹ (° C.) | T_{g}² (° C.) | (Pa * s) |
| CA-1 | white flake | | 167-207⁴ | |
| HPCE-1 | clear; stiff; brittle | | 80 | 93,777 |
| HPCE-2 | clear; flexible; tacky | | −55 | 7,187 |
| HPCE-3 | clear; flexible; | 150¹ | −53 | 2,417 |
| | stretchy; very tacky | | | |
| HPCE-4 | clear; stiff; brittle | 166² | Non detect | 122,456 |
| HPCE-5 | clear; stiff with some | 180² | 14 | 56,004 |
| | flexibility | | | |
| HPCE-6 | clear; flexible; tacky | 180¹ | 12 | 13,661 |
| CA-2 | white flake | | 167-207⁴ | |
| HPCE-7 | clear; flexible; | | −44 | 4,037 |
| | stretchy; tacky | | | |
| HPCE-8 | gel-like | | −61 | 4,037 |
| HPCE-9 | clear; flexible | | 15 | 23,230 |
| CA-3 | white flake | | 167-207⁴ | |
| HPCE-10 | clear; flexible; | | −57 | |
| | stretchy; tacky | | | |
| HPCE-11 | clear; coloured; | | −43 | |
| | tacky; flexible | | | |
| HPCE-12 | hard; glass-like; | | −35 | |
| | clear-yellow | | | |
| HPCE-13 | clear; flexible | | −53 | |
| HPCE-14 | clear; flexible | | −51 | |
| HPCE-15 | hard; glass-like; | | −34 | |
| | clear yellow | | | |
| HPCE-16 | clear; flexible | | −52 | |

¹Flow onset point as measured by visual inspection upon heating.
²Glass transition temperature/melt as measured by TA Instruments DSC Q2000.
³Complex viscosity at 140° C. by TA Instruments Rheometer Discovery HR-2.
⁴Literature values for cellulose acetate.

### Example 2

Samples HPCE-3, HPCE-6, HPCE-7, and HPCE-9 were tested for adherence between a glass surface and a cardboard surface. A portion of the sample was added to a glass slide and heated to between 60° C. and 100° C. Then a piece of cardboard was applied to the adhesive, which was then allowed to cool. The cardboard piece was then peeled from the glass slide.

Adhesion was achieved in all samples. Upon trying to separate the two substrates, the cardboard pieces adhered with samples HPCE-3, HPCE-6, and HPCE-7 were unable to be peeled without rupturing the cardboard. The cardboard piece adhered with sample HPCE-9 was able to be cleanly peeled from the glass slide.

### Example 3

HPCE-7 was tested for thermal stability by storing in a freezer for over 24 hours two paper surfaces glued together. Once warmed to room temperature, the paper surfaces were manually pulled and remained adhered together. Further, the seam where the HPCE-7 adhered to the two paper surfaces remained flexible after the temperature cycling. This example demonstrates, to at least some extent, the temperature stability of HPCE-adhesives.

### Example 4

Mixes of CA with intrinsic viscosities from 0.8 to 1.6 and triacetin content to CA ratio of 1:1 and 0.8:1 were prepared. The mixes were analyzed for the changes in melt temperature as a function of intrinsic viscosity. As shown in FIG. 2, a substantially linear relationship was observed where increased intrinsic viscosity yields a linear increase in melt temperature. Further, a higher plasticizer concentration yields a lower melt temperature at the same intrinsic viscosity. This example demonstrates the ability to tailor the flow onset temperature response by controlling intrinsic viscosity or plasticizer concentration of HPCE-adhesives.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1. A method comprising:
disposing an adhesive sheet between a first surface and a second surface, the adhesive sheet comprising an adhesive that comprises a cellulose ester and a plasticizer, the plasticizer included in an amount of about 30% to about 60% by weight of the adhesive; and
heating the adhesive sheet so as to adhere the first surface to the second surface.

2. The method of claim 1, wherein the cellulose ester has a degree of substitution between about 1.5 and about 2.7.

3. The method of claim 1, wherein the adhesive has a flow onset point between about 75° C. and about 180° C.

4. The method of claim 1, wherein the adhesive has a glass transition temperature between about 10° C. and about 190° C.

5. The method of claim 1, wherein the adhesive has no detectible glass transition temperature.

6. The method of claim 1, wherein the first surface and/or the second surface comprises at least one selected from the group consisting of a ceramic, a natural polymer, a synthetic polymer, a metal, a natural material, carbon, and any combination thereof.

7. The method of claim 1 further comprising:
producing an article selected from the group consisting of an envelope, tape, cardboard packaging, a mailing package, a food container, a cereal box, a frozen dinner container, a book, a notebook, a magazine, a corrugated box, a decorative box, a paper bag, a grocery bag, electric insulation paper, an air filter, furniture or a component thereof, carpet or fabric coated headboard, a chair, a stool, and a picture frame.

8. A method comprising:
compounding at least a cellulose ester and a plasticizer to yield an adhesive, the plasticizer included in an amount of about 30% to about 60% by weight of the adhesive; and
forming the adhesive into an adhesive sheet.

9. The method of claim 8, wherein the first surface and/or the second surface comprises at least one selected from the group consisting of a ceramic, a natural polymer, a synthetic polymer, a metal, a natural material, carbon, and any combination thereof.

10. The method of claim 8 further comprising:
absorbing an additive into the adhesive sheet, wherein the additive comprises at least one selected from the group consisting of a crosslinker, a lubricant, a softening agent, an antibacterial agent, an antifungal agent, a pigment, a dye, a flavorant, an aroma, and any combination thereof.

11-20. (canceled)

21. The method of claim 1, wherein the cellulose ester and the plasticizer are food-grade.

22. A method comprising:
disposing an adhesive sheet between a first surface and a second surface, the adhesive sheet comprising an adhesive that comprises a cellulose ester and a plasticizer, the plasticizer included in an amount of about 30% to about 60% by weight of the adhesive, wherein the plasticizer comprises an aroma; and
heating the adhesive sheet so as to adhere the first surface to the second surface.

23. The method of claim 22, wherein the cellulose ester and the plasticizer are food-grade.
